(19) United States
(12) Patent Application Publication
(10) Pub. No.: US 2021/0348694 A1
(43) Pub. Date: Nov. 11, 2021

(54) Separable Fireproof Cover for Valve Actuator

(71) Applicant: MOV Limited, Ulsan (KR)

(72) Inventor: Woo Sang Jang, Ulsan (KR)

(21) Appl. No.: 17/183,874

(22) Filed: Feb. 24, 2021

(30) Foreign Application Priority Data
Mar. 12, 2020 (KR) 10-2020-0030551

(51) Int. Cl. F16K 27/12; C03C 4/00; C09K 21/14; B32B 17/00; A62C 2/06

(52) U.S. Cl. CPC F16K 27/12; C03C 4/00; C03B 19/025; B32B 17/00; A62C 2/06; C09K 21/14

(57) ABSTRACT

Proposed is a separable fireproof cover for a valve actuator, the cover including: a plurality of parts, wherein one of the plurality of parts includes: a heat-blocking fireproof glass window in a shape of a circular plate; and a solid fireproof agent provided around an edge of the heat-blocking fireproof glass window, and the one of the plurality of parts is injection-molded by injecting the heat-blocking fireproof glass window and a liquefied fireproof agent into a mold into which a zinc-coated mesh is provided, the liquefied fireproof agent being obtained by mixing epoxy-based Chartek A and Chartek B in a 2.44:1 weight ratio.

### CROSS REFERENCE TO RELATED APPLICATION

The present application claims priority to Korean Patent Application No. 10-2020-0030551, Mar. 12, 2020 filed the entire contents of which is incorporated herein for all purposes by this reference.

### BACKGROUND OF THE INVENTION

### Field of the Invention

The present disclosure relates to a fireproof cover for a valve actuator.

### Description of the Related Art

Generally, a tank storing a flammable material is installed in a petrochemical plant, a gas station, and the like. For safety precautions, an emergency blocking valve is obligatorily installed on a pipe connected to such a tank, and the emergency blocking valve is driven by a valve actuator.

When a fire occurs, the valve actuator is required to operate in a high temperature environment for a certain time. Thus, the valve actuator is obligatorily required to be fireproofed.

Korean Utility Model Application Publication No. 20-0450484 discloses a separable fireproof cover for a valve actuator, which is configured to include parts that partly surround a surface of the valve actuator.

In a case where the fireproof cover disclosed in Korean Utility Model Registration No. 20-0450484 is mounted on the valve actuator, one (a part covering a gage) of the parts is required to be opened (separated) in order to monitor readings shown on the gage on the valve actuator.

The foregoing is intended merely to aid in the understanding of the background of the present disclosure, and is not intended to mean that the present disclosure falls within the purview of the related art that is already known to those skilled in the art.

### DOCUMENT OF RELATED ART

(Patent Document 1) Korean Utility Model Registration No. 20-0450484 (published on Oct. 6, 2010)

### SUMMARY OF THE INVENTION

An objective of the present disclosure is to provide a separable fireproof cover for a valve actuator, the cover being configured to include a plurality of parts. The separable fireproof cover is capable of easily monitoring readings shown on a gage on the valve actuator without opening (separating) one of the plurality of parts.

According to an aspect of the present disclosure, there is provided a separable fireproof cover for a valve actuator, the cover including: a plurality of parts, wherein one of the plurality of parts includes: a heat-blocking fireproof glass window in a shape of a circular plate; and a solid fireproof agent provided around an edge of the heat-blocking fireproof glass window.

In the cover, the one of the plurality of parts may be injection-molded by injecting the heat-blocking fireproof glass window and a liquefied fireproof agent into a mold into which a zinc-coated mesh is provided, the liquefied fireproof agent being obtained by mixing epoxy-based Chartek A and Chartek B in a 2.44:1 weight ratio, and parts other than the one of the plurality of parts may be injection-molded by injecting a liquefied fireproof agent into a mold into which a zinc-coated mesh is provided, the liquefied fireproof agent being obtained by mixing epoxy-based Chartek A and Chartek B in a 2.44:1 weight ratio.

In the cover, the heat-blocking fireproof glass window may be formed by bonding four fireproof glass sheets, each having a thickness of 4 mm to 5 mm, using fireproof resins.

In the cover, the solid fireproof agent may overlap the edge of the heat-blocking fireproof glass window, and an overlapping area may range from 30% to 50% of an area of the heat-blocking fireproof glass window.

In a case where the separable cover for the valve actuator according to an embodiment of the present disclosure is mounted on the valve actuator, readings shown on a gage on the valve actuator can be easily monitored through the heat-blocking fireproof glass window.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view schematically illustrating a separable cover for a valve actuator according to an embodiment of the present disclosure; and

FIG. 2 is a view illustrating a state where one part (a part equipped with a fireproof glass window) of the separable fireproof cover for the valve actuator according to the embodiment of the present disclosure is cut in half.

### DETAILED DESCRIPTION OF THE INVENTION

A separable fireproof cover for a valve actuator according to an embodiment of the present disclosure will be described in detail with reference to the accompanying drawings.

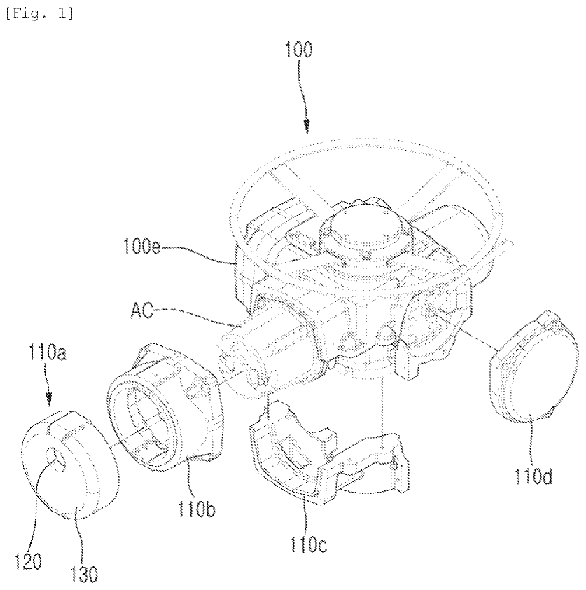

FIG. 1 is a perspective view schematically illustrating a separable fireproof cover 100 for the valve actuator according to the embodiment of the present disclosure.

With reference to FIG. 1, the separable fireproof cover 100 for the valve actuator according to the embodiment of the present disclosure is configured to include a plurality of parts 110a, 110b, 110c, 110d, and 110e that surround an actuator AC. A shape of each part illustrated in each of the drawings and the number of parts that constitute the separable fireproof cover are only exemplary. The parts are not limited to specific shapes, nor are limited in number.

The plurality of parts 110a, 110b, 110c, 110d, and 110e are configured to be combined with each other using mechanical elements such as a bolt and a nut.

The part 110a (a part positioned in front of a gage on the actuator AC), one of the plurality of parts 110a, 110b, 110c, 110d, and 110e, is configured to include a heat-blocking fireproof glass window 120 in the shape of a circular plate and a solid fireproof agent 130 provided around an edge of the heat-blocking fireproof glass window 120.

The solid fireproof agent 130 overlaps the edge of the heat-blocking fireproof glass window 120, and an overlapping area ranges from 30% to 50% of an area of the heat-blocking fireproof glass window 120. In this case, the heat-blocking fireproof glass window 120 has a remarkably low likelihood of being damaged when exposed to high temperature heat for a long time.

The above-described part 110a, the one of the plurality of parts, is injection-molded by injecting the heat-blocking fireproof glass window 120 and a liquefied fireproof agent into a mold into which a zinc-coated mesh is provided. The liquefied fireproof agent is obtained by mixing epoxy-based Chartek A and Chartek B in a 2.44:1 weight ratio.

Chartek A and Chartek B are epoxy resin developed by AkzoNobel headquartered in the Netherlands.

Chartek A is dark gray in color and is not mixed when having a very low viscosity. Thus, for later use, Chartek A is stored at a temperature ranging from 23° C. to 30° C. for 24 hours to 48 hours.

In contrast, Chartek B is ivory in color and maintains a constant viscosity, thereby being convenient for storage.

The parts 110b, 110c, 110d, and 110e other than the above-described part 110a are injection-molded by injecting the liquefied fireproof agent into the mold into which the zinc-coated mesh is provided. The liquefied fireproof agent is obtained by mixing epoxy-based Chartek A and Chartek B in the 2.44:1 weight ratio.

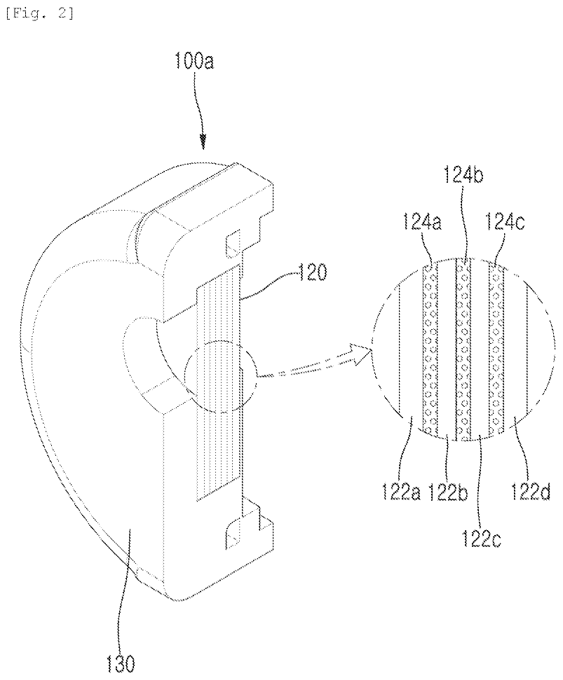

FIG. 2 is a view illustrating a state where the part 110a, which is one part of the separable fireproof cover 100 for the valve actuator according to the embodiment of the present disclosure, is cut in half.

With reference to FIG. 2, the heat-blocking fireproof glass window 120 is formed by bonding four fireproof glass sheets 122a, 122b, 122c, and 122d, each having a thickness of 3 mm to 5 mm, using fireproof resins 124a, 124b, and 124c that are interposed between the fireproof glass sheets 122a and 122b, the fireproof glass sheets 122b and 122c, and the fireproof glass sheets 122c and 122d, respectively.

According to UL Standard 1709 (Rapid Rise Fire Tests of Protection Materials) stipulated by American National Standards Institute (ANSI), a product subject to protection should be protected in such a manner as to operate at a temperate of 1093° C. for a minimum of 30 minutes. In a case where the heat-blocking fireproof glass window 120 is configured to include the four fireproof glass sheets 122a, 122b, 122c, and 122d, the two fireproof glass sheets 122a and 122d positioned outermost are configured to have a thickness of 5 mm, the two fireproof glass sheets 122b and 122c positioned innermost are configured to have a thickness of 4 mm, and the fireproof resins 124a, 124b, and 124c are configured to have a thickness of 3 mm. Thus, the heat-blocking fireproof glass window 120 has a performance level similar to that of the fireproof agent 130 that is solidified after being injection-molded by injecting in the mold the liquefied fireproof agent obtained by mixing epoxy-based Chartek A and Chartek B in the 2.44:1 weight ratio. * “KOREA INSTITUTE of CIVIL ENGINEERING and BUILDING TECHNOLOGY” implemented testing and evaluation for fire safety after the separable fireproof cover for the valve actuator according to the embodiment of the present disclosure was installed on a general-type actuator. The result (KICT-R-K-2019-00577-1) shows that an average temperature inside the actuator was measured as 23.5° C. at a point in time when 30 minutes had elapsed since the occurrence of a fire.

A method of manufacturing the part 122a equipped with the heat-blocking fireproof glass window 120 is described.

First, 41 g of Chartek B that is a hardener, is prepared as a required amount for 100 g of Chartek A that is an undiluted solution of epoxy resin. Chartek A and Chartek B are to be mixed with each other in the 2.44:1 weight ratio later.

A pre-operation ambient condition is that atmospheric temperature is maintained at or above a minimum of 10 degrees and that maximum relative humidity is maintained at or below 85%.

Subsequently, Chartek A that is stored at a temperature of 23° C. or higher for 24 hours or more is stirred.

Then, Chartek A is mixed with Chartek B until a texture of the resulting mixture becomes smooth and has a consistent gray color. At this point, atmospheric temperature is maintained at 10° C. to 40° C.

Subsequently, a mold is prepared. A mesh that has the shape of a rectangle with a size of 12 mm to 15 mm and is zinc-coated is provided into the mold.

Subsequently, the heat-blocking fireproof glass window and the liquefied fireproof agent, which is obtained by mixing Chartek A and Chartek B in the 2.44:1 weight ratio, are inserted into the mold. When pressure is applied within the mold and the liquefied fireproof agent is dried for 4 hours to 12 hours, the liquefied fireproof agent becomes a solid fireproof agent. The part 122a configured to include the heat-blocking fireproof glass window 120 and the solid fireproof agent 130, as illustrated in FIG. 1, is manufactured.

In a case where the separable fireproof cover 100 for the valve actuator according to the embodiment of the present disclosure, which is configured to include the constituent elements described above, is mounted on the valve actuator AC, readings shown on the gage on the valve actuator AC are monitored through the heat-blocking fireproof glass window 120.

The expressions (including the terms, the visualized images, and the like) used in describing the embodiment of the present disclosure are not selected to impose any limitation on the technical idea of the present disclosure, and are selected only for the practical purpose of providing a full understanding of the technical idea thereof.

Furthermore, the preferred embodiment of the present disclosure is described above. Thus, it would be apparent to a person of ordinary skill in the art that a novel embodiment will be constructed on the basis of the preferred embodiment thereof within the scope of the technical idea of the present disclosure.

Therefore, claims of the present disclosure are not limited by several expressions used in “DETAILED DESCRIPTION OF THE INVENTION” and the “accompanying drawings”, and should be broadly interpreted in light of the technical idea that underlies “DETAILED DESCRIPTION OF THE INVENTION” and the “accompanying drawings”.

What is claimed is:

1. A separable fireproof cover for a valve actuator, the cover comprising:
a plurality of parts,
wherein one of the plurality of parts comprises:
a heat-blocking fireproof glass window in a shape of a circular plate; and
a solid fireproof agent provided around an edge of the heat-blocking fireproof glass window.

2. The cover of claim 1 wherein the one of the plurality of parts is injection-molded by injecting the heat-blocking fireproof glass window and a liquefied fireproof agent into a mold into which a zinc-coated mesh is provided, the liquefied fireproof agent being obtained by mixing epoxy-based Chartek A and Chartek B in a 2.44:1 weight ratio.

3. The cover of claim 2, wherein the heat-blocking fireproof glass window is formed by bonding four fireproof glass sheets, each having a thickness of 4 mm to 5 mm, using fireproof resins.

4. The cover of claim 1, wherein the solid fireproof agent overlaps the edge of the heat-blocking fireproof glass window, and an overlapping area ranges from 30% to 50% of an area of the heat-blocking fireproof glass window.

5. The cover of claim 1, wherein parts other than the one of the plurality of parts are injection-molded by injecting a liquefied fireproof agent into a mold into which a zinc-coated mesh is provided, the liquefied fireproof agent being obtained by mixing epoxy-based Chartek A and Chartek B in a 2.44:1 weight ratio.
